(19) United States
(12) Patent Application Publication
(10) Pub. No.: US 2007/0192801 A1
(43) Pub. Date: Aug. 16, 2007

(54) Method and apparatus for controlling scheduled recording service using external tuner

(75) Inventor: Young-chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/588,385

(22) Filed: Oct. 27, 2006

(30) Foreign Application Priority Data
Feb. 15, 2006 (KR) 10-2006-0014730

(51) Int. Cl. H04N 5/445; G06F 13/00; G06F 3/00

(52) U.S. Cl. 725/58; 725/39

(57) ABSTRACT

Provided are a method and apparatus for controlling a network device, and more particularly, a method and apparatus for scheduling recording by controlling another device connected to a network. The method of controlling a scheduled recording service using an external tuner includes detecting a device which supports a tuner on a network; and designating predetermined reservation information required to schedule transmitting broadcast contents which will be received by the tuner of the detected device, wherein the method is performed in a control point which does not include a tuner.

### CROSS-REFERENCE TO RELATED PATENT APPLICATIONS

This application claims the priority from Korean Patent Application No. 10-2006-0014730, filed on Feb. 15, 2006, in the Korean Intellectual Property Office, the disclosure of which is incorporated herein in its entirety by reference.

### BACKGROUND OF THE INVENTION

1. Field of the Invention

Apparatus and methods consistent with the present invention relate to controlling network devices, and more particularly, to scheduling recording by controlling a device connected to a network.

2. Description of the Related Art

According to the conventional art, when a viewer wants to schedule recording of a broadcast program, a device used to record requires a tuner and a storage device. Specifically, to schedule recording of a variety of broadcast programs such as satellite broadcasts, terrestrial broadcasts, and cable broadcasts, the device for recording has to include a tuner to receive all kinds of broadcast programs, and therefore the device is complicated and the manufacturing costs are high.

### SUMMARY OF THE INVENTION

Exemplary embodiments of the present invention provide a method and apparatus for scheduling recording, in which a control device on a network, i.e. a control point, controls a device that supports a tuner.

Exemplary embodiments of the present invention also provide a computer readable medium having recorded thereon a computer readable program for performing the method of scheduling recording.

According to an aspect of the present invention, there is provided a method of controlling a scheduled recording service using an external tuner, the method comprising: detecting a device which supports a tuner on a network; and designating predetermined reservation information required to schedule transmitting broadcast contents which will be received by the tuner of the detected device, wherein the method is performed in a control point which does not include a tuner.

According to another aspect of the present invention, there is provided an apparatus for controlling a scheduled recording service using an external tuner, the apparatus comprising: a discovery module that detects a device on a network; a description module that obtains a service description provided by the device detected by the discovery module; and a control module that detects a device which supports a tuner based on the service description obtained by the description module and schedules the detected device to transmit a broadcast program received on a predetermined channel at a predetermined time to a control point device, wherein the apparatus is included in a control point that detects the device on the network.

According to still another aspect of the present invention, there is provided a computer readable recording medium having embodied thereon a computer program for executing the methods of providing a scheduled recording service.

According to yet another aspect of the present invention, there is provided a method of processing scheduled transmission of a broadcast program, the method comprising: transmitting a service description provided by a device to a control point; and controlling a tuner to receive a broadcast program on a predetermined channel at a predetermined time and transmit the broadcast program to a control point device according to a tuner reservation of the control point which received the service description, wherein the method is performed in the device which supports the tuner that is detected and controlled by the control point on a network.

According to another aspect of the present invention, there is provided an apparatus for processing scheduled transmission of a broadcast program, the apparatus comprising: a discovery module that transmits a message advertising a device to a control point; a description module that transmits a service description of a device in response to a request of the control point, the service description including tuner service information; and a control module that controls a broadcast program received on a predetermined channel at a predetermined time according to tuner reservation to be transmitted to a control point device, where the tuner reservation designated in response to a request of the control point based on the tuner service information is included in the service description of the device, wherein the apparatus is included in the device which supports a tuner that is detected and controlled by the control point on a network.

According to another aspect of the present invention, there is provided a computer readable recording medium having embodied thereon a computer program for executing the methods of processing scheduled transmission of a broadcast program in the device supporting the tuner.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a configuration of an apparatus for controlling a scheduled recording service according to an exemplary embodiment of the present invention;

FIG. 2 is a flowchart illustrating a method of controlling a scheduled recording service in a control point that does not include a tuner according to an exemplary embodiment of the present invention;

FIG. 3 is a flowchart illustrating a method of providing a scheduled recording service in a device supporting a tuner according to an exemplary embodiment of the present invention;

FIG. 4 shows actions and responses between a device including a tuner and a control device, i.e. a control point that does not include a tuner, to provide a scheduled recording service according to an exemplary embodiment of the present invention; and

FIG. 5 shows a description of a device supporting a tuner according to an exemplary embodiment of the present invention.

### DETAILED DESCRIPTION OF THE EXEMPLARY EMBODIMENTS

In the present invention, a network may be a UPnP (Universal Plug and Play) based network. However, the present invention is not limited to the UPnP based network, and a variety of network access technologies such as Digital Living Network Alliance (DLNA) are applicable to the present invention.

A UPnP based network allows convenient communications between devices such as information electric appliances, wireless communication devices, and PC related devices which are located in various locations.

Such UPnP based network access technology is made by expanding PnP (Plug and Play), which is used for peripheral device access to Microsoft WINDOWS by the Microsoft Corporation, such that the PnP can be applied to a greater variety of devices. Devices connected to the UPnP based network are categorized into control devices and controlled devices. In general, the control devices are referred to as control points, and the controlled devices are referred to simply as devices.

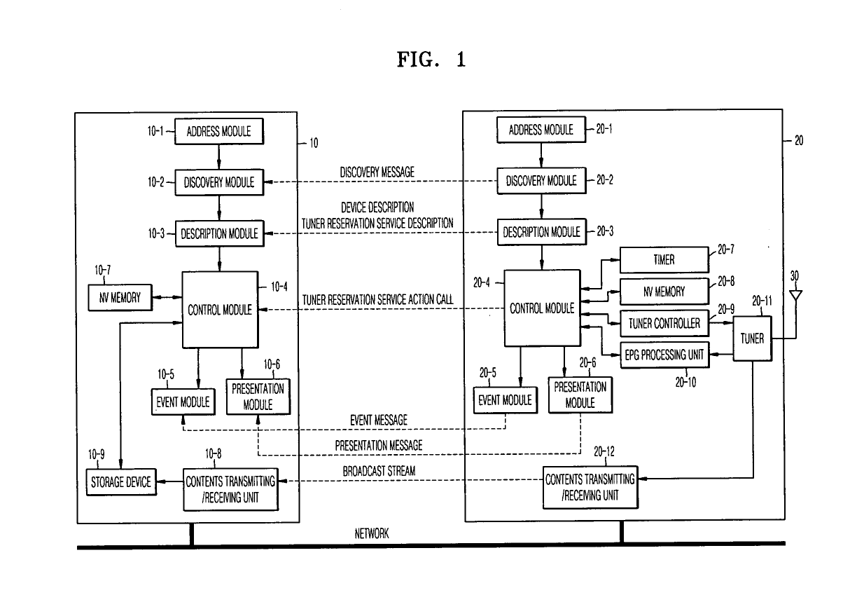

FIG. 1 is a block diagram illustrating a configuration of an apparatus for controlling a scheduled recording service using an external tuner according to an exemplary embodiment of the present invention. Referring to FIG. 1, the scheduled recording service control apparatus of a control point 10 includes an address module 10-1, a discovery module 10-2, a description module 10-3, a control module 10-4, an event module 10-5, a presentation module 10-6, a non-volatile (NV) memory 10-7, a contents transmitting/receiving unit 10-8, and a storage device 10-9.

The address module 10-1 performs a UPnP addressing operation. Specifically, the address module 10-1 determines an IP address of the control point 10. More particularly, if a dynamic host configuration protocol (DHCP) server (not shown) is present on the network, the DHCP server allocates a certain IP address to the address module 10-1 so that the IP address is determined as the IP address of the control point 10. If a DHCP server is not present on the network, the address module 10-1 obtains an IP address using an auto-IP address, and the IP address is determined as an IP address of the control point 10.

The discovery module 10-2 performs a UPnP discovery operation. Specifically, the discovery module 10-2 detects a device 20 on the network, using the IP address of the control point 10 which has been determined by the address module 10-1. If the device 20 has been added to the network, the discovery module 10-2 receives a discovery message advertising the device 20 from the device 20 and thus detects the device 20 on the network.

The description module 10-3 performs a UPnP description operation. In particular, the description module 10-3 obtains a description of the device 20 from the device 20 which has been detected by the discovery module 10-2. More specifically, the description module 10-3 obtains the description of the device 20 from a uniform resource locator (URL) of a device description, that is “URL for UPnP description for root device”, included in the discovery message obtained from the device 20.

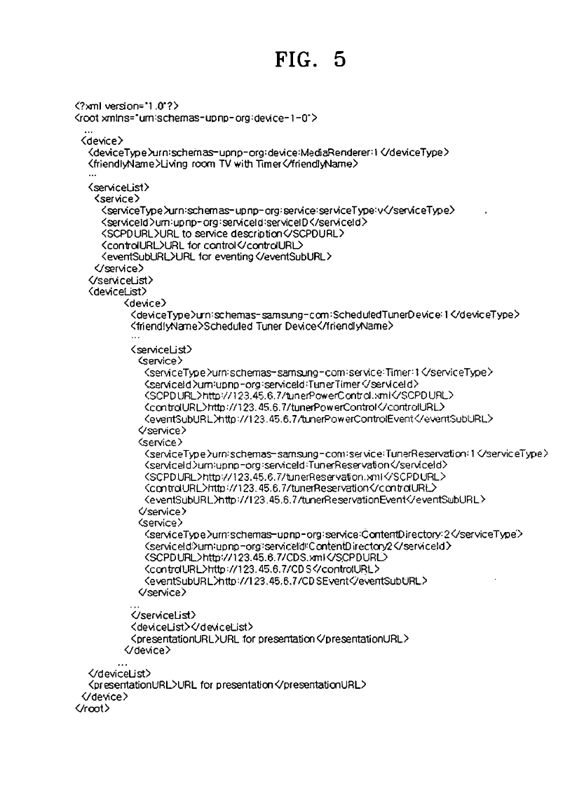

FIG. 5 shows a device supporting a tuner according to an exemplary embodiment of the present invention. Referring to FIG. 5, it can be ascertained from “<serviceType> urn:schemas-samsung-com:service:Timer:1</serviceType>” that the device 20 provides a timer service. Furthermore, it can be ascertained from “<serviceType>urn:schemas-samsung-com:service:TunerReservation:1 <serviceType>” that the device 20 provides a tuner reservation service.

In addition, the description module 10-3 obtains a description of services the device 20 provides from a URL of a service description, that is, “URL to service description” shown in FIG. 5, included in the description of the device 20. In particular, according to the present exemplary embodiment, the description module 10-3 obtains a description of the tuner reservation service from a URL of a tuner reservation service description, that is, “<SCPDURL>http://123.45.6.7tunerReservation.xml<SCPDURL>” shown in FIG. 5, included in the description of the device 20.

The control module 10-4 performs a UPnP control operation. The control module 10-4 controls the device 20 based on the description of the device 20 which has been obtained by the description module 10-3. More specifically, the control module 10-4 calls one of the actions included in a description of a service with respect to a URL for controlling the service, that is, “URL for control”, which is included in the description of the device 20 such that the control module 10-4 controls the device 20.

According to the present exemplary embodiment, the control module 10-4 sets the device 20, which supports a tuner and has been detected by the discovery module 10-2, to transmit broadcast contents which a scheduled channel will receive at a scheduled time, to the storage device 10-9 of the control point 10. More specifically, the control module 10-4 invokes one of the actions included in the description of the tuner reservation service provided by the device 20, based on the tuner reservation service description obtained by the description module 10-3, so that the control module 10-4 sets the tuner reservation such as a predetermined time to start recording, a predetermined time to finish recording, and a channel on which a program to be recorded will be broadcast.

The event module 10-5 performs a UPnP event operation. The event module 10-5 receives an event message indicating a change has occurred in a state of the device 20 from the device 20 controlled by the control module 10-4.

The presentation module 10-6 performs a UPnP presentation operation. The presentation module 10-6 shows the device 20 to a user based on the description of the device 20 obtained by the description module 10-3. More specifically, the presentation module 10-6 requests a page to be shown with respect to a URL of a shown page, that is, “URL for presentation”, and obtains the page to be shown after receiving a response to the request. Also, the presentation module 10-6 loads the page to a browser (not shown) to show the page to the user. The browser may be included in the control point 10, the device 20, or another device.

The NV memory 20-8 stores information related to the tuner reservation service of the device 20. The contents transmitting/receiving unit 10-8 receives broadcast streams that are transmitted according to information of the tuner reservation of the device 20, and transmits them to the storage device 10-9.

The storage device 10-9 stores data, and may be a hard disk drive.

The broadcast streams, which have been transmitted according to a tuner reservation service action to the set channel of the device 20 at a scheduled time, are stored in the storage device 10-9 of the control point 10 under the control of the control module 10-4.

Referring to FIG. 1, according to the exemplary embodiment of the present invention, an apparatus for controlling a scheduled recording service of the device 20 includes an address module 20-1, a discovery module 20-2, a description module 20-3, a control module 20-4, an event module 20-5, a presentation module 20-6, a timer 20-7, an NV memory 20-8, a tuner controller 20-9, an electronic program guide (EPG) processing unit 20-10, a tuner 20-11, and a contents transmitting/receiving unit 20-12.

The address module 20-1 performs a UPnP addressing operation. The address module 20-1 determines an IP address of the device 20. More specifically, if a DHCP server (not shown) is present on a network, the DHCP server allocates a certain IP address to the address module 20-1 and the address module 20-1 determines the IP address as an IP address of the device 20. If a DHCP server is not present on a network, the address module 20-1 obtains an IP address using an auto IP address and determines the IP address as an IP address of the device 20.

The discovery module 20-2 performs a UPnP discovery operation. The control point 10, which is on the network, detects the discovery module 20-2 using the IP address of the device 20, which has been determined by the address module 20-1. In a case where the device 20 has been added to the network, the discovery module 20-2 transmits a discovery message advertising the device 20 to the control point 10 so that the control point 10 can detect the device 20 on the network. In a case where the control point 10 has been added to the network, the discovery module 20-2 receives a message that the control point 10 sends to detect devices on the network, and transmits a discovery message that advertises the device 20 in response to the message for detection, so that the control point 10 can detect the device 20 on the network.

The description module 20-3 performs a UPnP description operation. The description module 20-3 provides the description of the device 20 to the control point 10, which received the discovery message transmitted from the discovery module 20-2. More specifically, the description module 20-3 provides a description of the device 20 to the control point 10 when the control point 10 accesses a URL for the device description, that is, “URL for UPnP description for root device”, which is included in the discovery message.

In addition, the description module 20-3 provides the control point 20 with a description of a service the device 20 provides when the control point 10 accesses a URL for the service description, that is, “URL to service description”, which is included in the description of the device 20 supporting the tuner shown in FIG. 5. In particular, according to the present exemplary embodiment, the description module 20-3 provides the control point 10 with the description of the tuner reservation service when the control point 10 accesses a URL for the tuner reservation service description, that is, “<SCPDURL>http://123.45.6.7/tunerReservation.xml</SCPDURL>”, which is included in the description of the device 20.

Moreover, the description module 20-3 provides the control point 10 with a description of a service that a device embedded in the device 20 provides when the control point 10 accesses a URL to obtain a service description provided by the device embedded in the device 20, that is, “URL to service description”, which is included in the description of the device 20 shown in FIG. 5. In particular, according to the present exemplary embodiment, the description module 20-3 provides the control point 10 with the description of the tuner reservation service when the control point 10 accesses a URL referring to the tuner reservation service, that is, “<SCPDURL>http://123.45.6.7/tunerReservation.xml</SCPDURL>”, which is included in the description of the device 20 shown in FIG. 5.

The control module 20-4 performs a UPnP control operation. The control module 20-4 is controlled by the control point 10 that obtained the description, provided from the description module 20-3, of the device 20 supporting the tuner. More specifically, when the control point 10 accesses a URL for controlling a certain service, that is, “URL for control”, which is included in the description of the device 20, and invokes one of the actions included in the description of the service the device 20 provides, the control module 20-4 controls the device 20.

In particular, according to the present exemplary embodiment, when the control module 20-4 receives the discovery message from the discovery module 20-2 and receives a message that the device 20 is set to transmit broadcast contents, which will be broadcast on a predetermined channel at a predetermined time, to the storage device 10-9 of the control point 10 from the control point 10 that obtained the descriptions about the device 20 and tuner reservation service provided by the device 20, the control module 20-4 performs scheduled operations according to the schedule of the control point 10.

Furthermore, when the control module 20-4 receives a message that the device embedded in the device 20 is set to perform a predetermined command at a predetermined time from the control point 10 that obtained the description of the tuner reservation service provided by the embedded device, the control module 20-4 performs the predetermined command for the embedded device at the predetermined time according to the schedule of the control point 10.

More particularly, when the control module 20-4 receives, from a control point 10, a call for an action of the tuner reservation service to schedule the device 20 to receive broadcast contents which will be broadcast on a predetermined channel at a predetermined time and transmit the broadcast contents to the storage device 10-9 of the control point 10, the control module 20-4 registers the action call to a tuner reservation service in the control module 20-4. Then, the control module 20-4 stores the tuner reservation service information in the NV memory 20-8.

When a time shown in the timer 20-7 reaches the scheduled time according to the tuner reservation service information, the control module 20-4 instructs the tuner controller 20-9 to supply power to the tuner 20-11 and change a channel of the tuner 20-11 to the scheduled channel according to the tuner reservation service information. When the tuner reservation service time ends, the control module 20-4 instructs the tuner controller to cut off the power supply to the tuner 20-11.

The NV memory 20-8 is a non-volatile memory in which the tuner reservation service information is stored when the control module 20-4 receives the call for the action of the tuner reservation service from the control point 10.

The timer 20-7 determines a time and informs to the control module 20-4 of the time.

The EPG processing unit 20-10 edits the electronic program guide (EPG) information, that is, additional information included in broadcast signals so that the EPG information can be displayed in a graphic manner.

The event module 20-5 performs a UPnP event operation. The event module 20-5 transmits an event message informing about a change in the state of the device 20 controlled by the control point 10.

The presentation module 20-6 performs a UPnP presentation operation. The presentation module 20-6 provides the control point 10 with information for presenting the device 20. More specifically, the presentation module 20-6 provides a presenting page to the control point 10 when the control point 10 accesses a URL of the presenting page, that is, “URL for presentation”.

In particular, in the present exemplary embodiment, the presentation module 20-6 provides the control point 10 with a page showing a channel reservation list of the tuner 20-11. Additionally, the presentation module 20-6 provides the control point 10 with a page showing an EPG list.

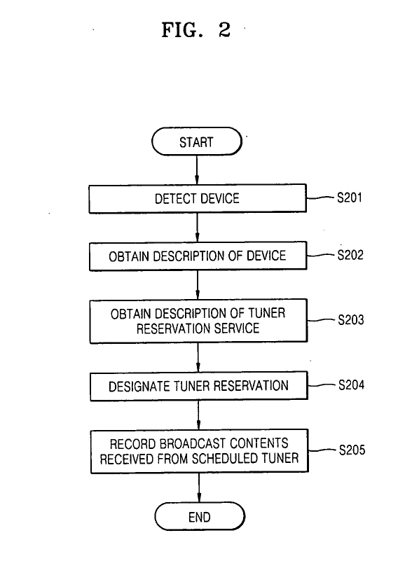

FIG. 2 is a flowchart illustrating a method of controlling a control point which does not include a tuner according to an exemplary embodiment of the present invention. The method illustrated in FIG. 2 includes operations corresponding to those performed in time series in the control point 10 illustrated in FIG. 1. Therefore, although operations will be omitted in the following description, if the operations correspond to those related to the control point 10 illustrated in FIG. 1, they are applicable to the method illustrated in FIG. 2 according to the present exemplary embodiment.

The control point 10 receives the discovery message advertising the device 20 from the device 20 and thus discovers the device 20 (S201).

After discovery of the device 20, the control point 10 obtains the description of the device 20 from the discovered device 20 (S202).

Then, the control point 10 obtains the description of the tuner reservation service provided by the device 20, from a URL related to the tuner reservation service description included in the description of the device 20, which was obtained in operation S202 (S203).

The control point 10 calls one of the actions included in the description of the tuner reservation service that the device 20 provides, based on the tuner reservation service description which was obtained in operation S203, and sets tuner reservation information so that the device 20 is scheduled to transmit broadcast contents, which will be transmitted on a predetermined channel at a predetermined time to the storage device 10-9 of the control point 10 (S204).

At the time scheduled in operation S204, the broadcast contents are transmitted from the device 20 and recorded in the storage device 10-9 of the control point 10.

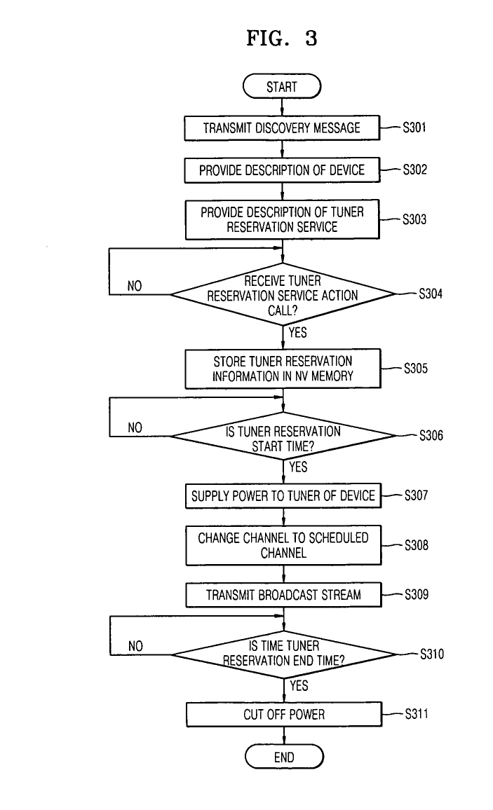

FIG. 3 is a flowchart illustrating a method of processing broadcast contents, scheduled to transmit to a control point from a device which supports a tuner and is detected and controlled by the control point on a network.

The method illustrated in FIG. 3 includes operations corresponding to the operations performed in time series in the device 20 illustrated in FIG. 1. Therefore, although operations will be omitted in the following description, if the operations correspond to those related to the device 20 illustrated in FIG. 1, they are applicable to the processing method according to the present exemplary embodiment.

The device 20 transmits the discovery message advertising the device 20 to the control point 10 so that the control point 10 can detect the device on a network (S301).

The device 20 provides the description of the device 20 to the control point 10 which received the discovery message (S302).

When the control point 10, which obtained the description of the device 20, accesses the URL related to the tuner reservation service description of the device 20, the device 20 provides the control point 10 with the description of the tuner reservation service (S303).

If the device 20 receives a call for one of the actions included in the description of the tuner reservation service from the control point 10 which obtained the description of the tuner reservation service, operation S305 is performed, or if the device 20 does not receive a call, the device 20 goes into stand-by mode (S304).

In operation S305, the device 20 stores in the NV memory 20-8 tuner reservation information, such as a tuner reservation start time, a tuner reservation end time, a channel number, user ID, etc., designated according to the action call received in operation S304.

Then, the device 20 determines whether or not a time shown in timer 20-7 corresponds to the tuner reservation start time stored in the NV memory 20-8, and if the time is the tuner reservation start time, operation S307 is performed; otherwise, the device 20 goes into stand-by mode.

In operation S307, if the time was determined as the scheduled start time in operation S306, the device 20 supplies power to the tuner 20-11.

Next, the device 20 changes the channel to a scheduled channel of the tuner 20-11, based on the tuner reservation information stored in the NV memory 20-8 (S308).

After changing the channel, the device 20 transmits broadcast contents broadcast on the changed channel to the storage device 10-9 of the control point 10 (S309).

The device 20 determines whether or not a time shown in the timer 20-7 corresponds to a tuner reservation end time stored in the NV memory 20-8 while transmitting the broadcast contents to the storage device 10-9 (S310).

In operation 311, when the time is determined as the tuner reservation end time in operation S310, the device 20 cuts off the power supply to the tuner 20-9.

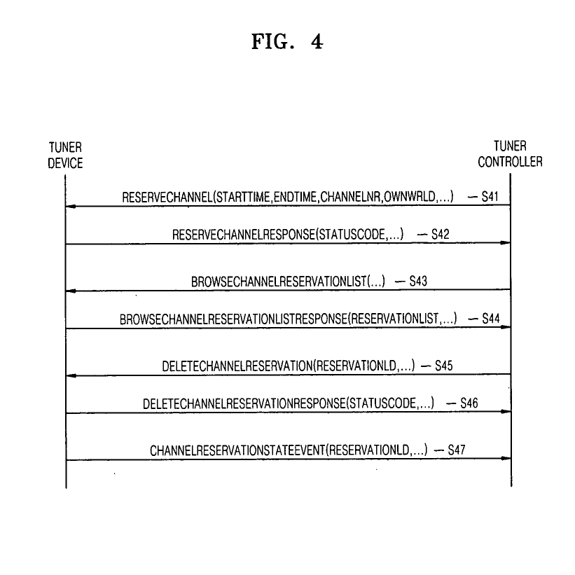

FIG. 4 shows actions and responses between a device (denoted as tuner device) supporting a tuner and a control point (denoted as a tuner controller) to provide a scheduled recording service according to an exemplary embodiment of the present invention.

When the tuner controller requests an action related to tuner reservation, that is, “ReserveChannel(startTime,endTime,channel1Nr, ownerID, . . . )” to the device (S41), the device 20 processes the tuner reservation request and transmits the processing result of the tuner reservation request to the tuner controller (S42). Through such procedures, the tuner controller can schedule the tuner device to set its “startTime”, “endTime” and “channelNr”.

Then, when the tuner controller requests an action “BrowseChannelReservationList” from the tuner device to check a current schedule state of the tuner (S43), the tuner device transmits “BrowseChannelReservationListResponse(reservationList, . . . )” to the tuner controller in response to the action (S44). Through such procedures, the tuner controller is informed of the current schedule state of the tuner included in the device 20 connected to the network.

When the tuner controller requests an action “DeleteChannelReservation(reservationid, . . . )” to the tuner device to cancel the tuner reservation which was previously designated in the tuner (S45), the tuner device provides the tuner controller with information informing it of the result of processing the tuner reservation cancellation request, that is, “DeleteChannelReservation(reservationid, . . . )” (S46). Through such procedures, the tuner reservation can be canceled.

When a change occurs in reservation information due to a request of a user or the like, the tuner device transmits event information, that is, “ChannelReservationStateEvent(reservationid, . . . )”, to the tuner controller to inform it of the changes (S47).

As described above, according to the present invention, a control point reserves a tuner included in a device on a network, and controls the device to receive broadcast contents using the reserved tuner and transmit the contents to a storage device. Therefore, another device without a tuner on the network can be provided a scheduled recording function. In other words, all kinds of broadcasts such as satellite broadcasts, terrestrial broadcasts, and cable broadcasts can be scheduled to be recorded in a single device without a tuner, and thus manufacturing costs for the tuner are reduced and it becomes easier to use.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a scheduled recording service using an external tuner, the method comprising:
detecting a device which supports a tuner on a network; and
designating predetermined reservation information required to schedule transmitting broadcast contents which will be received by the tuner of the detected device,
wherein the method is performed in a control point which does not include the tuner.

2. The method of claim 1, wherein the predetermined reservation information includes tuner reservation information.

3. The method of claim 2, wherein the tuner reservation information includes at least tuner power supply time information and channel information.

4. The method of claim 1, further comprising:
receiving broadcast contents which are scheduled to be transmitted from the device which supports the tuner according to the designated reservation information; and
recording the broadcast contents in a storage medium of the control point.

5. The method of claim 1, wherein in the detection of the device, a description of the device connected to the network is obtained to detect the device, the description including tuner service information.

6. The method of claim 1, wherein in the designation of the predetermined reservation information, a description of a service provided by a device embedded in the detected device is obtained and the reservation information is designated such that broadcast signals are transmitted to the control point, wherein the broadcast signals are broadcast signals that will be received on a scheduled channel at a scheduled time through a tuner device included in the embedded device, based on a service provided by the tuner device.

7. The method of claim 1, further comprising:
requesting all devices which support the tuner to provide electronic program guide information; and
obtaining the electronic program guide information of the tuner from the devices in response to the request,
wherein the designation of the predetermined reservation information includes designating the reservation information that determines which broadcast program will be received among the obtained electronic program guide information of the tuner.

8. The method of claim 1, further comprising:
requesting to provide information related to the tuner in all the devices which support the tuner; and
obtaining the information related to the tuner from the response to the request,
wherein the designation of the predetermined reservation information includes designating the reservation information that determines a broadcast program to be received, based on the information related to the tuner.

9. The method of claim 1, further comprising:
requesting to provide a list of tuner reservation information designated in the device;
obtaining the list from the response to the request; and
requesting to delete one of information from the obtained list.

10. An apparatus operable to control a scheduled recording service using an external tuner, the apparatus comprising:
a discovery module that detects a device on a network;
a description module that obtains a service description provided by the device detected by the discovery module; and
a control module that detects a device which supports a tuner based on the service description obtained by the description module and schedules the detected device to transmit a broadcast program received on a predetermined channel at a predetermined time to a control point,
wherein the apparatus is included in a control point that detects the device on the network.

11. The apparatus of claim 10, further comprising: a storage device that receives and stores the scheduled broadcast program from the device which supports the tuner, based on the schedule of the control point.

12. A computer readable recording medium having embodied thereon a computer program for executing a method of controlling a scheduled recording service using an external tuner, the method comprising:
detecting a device which supports a tuner on a network; and
designating predetermined reservation information required to schedule transmitting broadcast contents which will be received by the tuner of the detected device,
wherein the method is performed in a control point which does not include the tuner.

13. The computer program according to claim 12, wherein the predetermined reservation information includes tuner reservation information.

14. The computer program according to claim 13, wherein the tuner reservation information includes at least tuner power supply time information and channel information.

15. The computer program according to claim 12, wherein the method further comprises:
receiving broadcast contents which are scheduled to be transmitted from the device which supports the tuner according to the designated reservation information; and
recording the broadcast contents in a storage medium of the control point.

16. The computer program according to claim 12, wherein in the detection of the device, a description of the device connected to the network is obtained to detect the device, the description including tuner service information.

17. The computer program according to claim 12, wherein in the designation of the predetermined reservation information, a description of a service provided by a device embedded in the detected device is obtained and the reservation information is designated such that broadcast signals are transmitted to the control point, wherein the broadcast signals are broadcast signals that will be received on a scheduled channel at a scheduled time through a tuner device included in the embedded device, based on a service provided by the tuner device.

18. The computer program according to claim 12, wherein the method further comprises:
requesting all devices which support the tuner to provide electronic program guide information; and
obtaining the electronic program guide information of the tuner from the devices in response to the request,
wherein the designation of the predetermined reservation information includes designating the reservation information that determines which broadcast program will be received among the obtained electronic program guide information of the tuner.

19. The computer program according to claim 12, wherein the method further comprises:
requesting to provide information related to the tuner in all the devices which support the tuner; and
obtaining the information related to the tuner from the response to the request,
wherein the designation of the predetermined reservation information includes designating the reservation information that determines a broadcast program to be received, based on the information related to the tuner.

20. The computer program according to claim 12, wherein the method further comprises:
requesting to provide a list of tuner reservation information designated in the device;
obtaining the list from the response to the request; and
requesting to delete one of information from the obtained list.

21. A method for controlling a scheduled recording service using an external tuner, the method comprising:
transmitting a service description provided by a device to a control point; and
controlling a tuner to receive a broadcast program on a predetermined channel at a predetermined time and transmit the broadcast program to the control point according to a tuner reservation of the control point which received the service description,
wherein the method is performed in the device which supports the tuner that is detected and controlled by the control point on a network.

22. The method of claim 21, wherein the service description provided by the device includes tuner reservation service information.

23. The method of claim 22, wherein the tuner reservation service information includes electronic program guide information.

24. The method of claim 21, further comprising:
supplying power to the tuner of the device when a time is reached that is a time scheduled to transmit a predetermined broadcast program according to the tuner reservation,
wherein in the controlling of the tuner, a channel of the tuner is changed to the predetermined channel while the tuner is supplied with power and broadcast contents received on the predetermined channel are transmitted to the control point device.

25. The method of claim 21, further comprising:
providing tuner reservation service description of the device in response to the request of the control point,
wherein in the controlling of the tuner, the tuner is controlled to transmit the broadcast program received on the predetermined channel at the predetermined time to the control point according to the tuner reservation of the control point based on the tuner reservation service description.

26. The method of claim 21, further comprising:
providing a list of tuner reservation information designated in the device in response to a request of the control point; and
deleting one of information from the list in response to a request of the control point which obtained the list.

27. An apparatus for controlling a scheduled recording service using an external tuner, the apparatus comprising:
a discovery module that transmits a message advertising a device to a control point;
a description module that transmits a service description of a device in response to a request of the control point, the service description including tuner service information; and
a control module that controls a broadcast program received on a predetermined channel at a predetermined time according to tuner reservation to be transmitted to the control point, where the tuner reservation designated in response to a request of the control point based on the tuner service information is included in the service description of the device,
wherein the apparatus is included in the device which supports a tuner that is detected and controlled by the control point on a network.

28. A computer readable recording medium having embodied thereon a computer program for executing a method for controlling a scheduled recording service using an external tuner, the method comprising:
transmitting a service description provided by a device to a control point; and
controlling a tuner to receive a broadcast program on a predetermined channel at a predetermined time and transmit the broadcast program to the control point according to a tuner reservation of the control point which received the service description,
wherein the method is performed in the device which supports the tuner that is detected and controlled by the control point on a network.

29. The computer program according to claim 28, wherein the service description provided by the device includes tuner reservation service information.

30. The computer program according to claim 29, wherein the tuner reservation service information includes electronic program guide information.

31. The computer program according to claim 28, wherein the method further comprises:
supplying power to the tuner of the device when a time is reached that is a time scheduled to transmit a predetermined broadcast program according to the tuner reservation,
wherein in the controlling of the tuner, a channel of the tuner is changed to the predetermined channel while the tuner is supplied with power and broadcast contents received on the predetermined channel are transmitted to the control point device.

32. The computer program according to claim 28, wherein the method further comprises:
providing tuner reservation service description of the device in response to the request of the control point,
wherein in the controlling of the tuner, the tuner is controlled to transmit the broadcast program received on the predetermined channel at the predetermined time to the control point according to the tuner reservation of the control point based on the tuner reservation service description.

33. The computer program according to claim 28, wherein the method further comprises:
providing a list of tuner reservation information designated in the device in response to a request of the control point; and
deleting one of information from the list in response to a request of the control point which obtained the list.
